(19) United States
(12) Patent Application Publication
(10) Pub. No.: US 2008/0000716 A1
(43) Pub. Date: Jan. 3, 2008

(54) Production Facility for Speaker Diaphragm, Method of Manufacturing Speaker Diaphragm Using the Production Facility, and Speaker Diaphragm

(75) Inventors: Kenichi Ajiki, Mie (JP); Hironori Tabata, Mie (JP); Kazuyoshi Mimura, Mie (JP); Masahide Sumiyama, Mie (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/568,556

(22) PCT Filed: Jun. 22, 2005
(86) PCT No.: PCT/JP05/11413

§ 371 Date: Nov. 1, 2006

(30) Foreign Application Priority Data
Jun. 28, 2004 (JP) JP 2004-189174
Jun. 28, 2004 (JP) JP 2004-189175

(51) Int. Cl. H04R 31/00

(52) U.S. Cl. 181/167; 264/500; 425/149

(57) ABSTRACT

A production facility for a speaker diaphragm capable of forming a sheet-like film material by stepwise controlling the pressure and the flow of compressed air in air-pressure forming and a method of manufacturing the diaphragm by using the production facility. Since the diaphragm can be accurately molded and the stability of the dimension and the shape of the diaphragm can be increased, the diaphragm with high quality tone can be provided, and the productivity, quality, and reliability of the diaphragm can be increased.

This application is a U.S. National Phase Application of PCT International Application PCT/JP2005/011413.

### TECHNICAL FIELD

The present invention relates to a speaker diaphragm used in various acoustic equipment. In particular, the present invention relates to a production facility for a speaker diaphragm made of resin and to a method of manufacturing the speaker diaphragm.

### BACKGROUND ART

As a speaker diaphragm, paper, metal, resin, and the like, have been conventionally used, and appropriately selected depending upon features, intended uses, or the like, of respective materials. Among them, from the viewpoint of miniaturization and lowering of the cost, diaphragms made of resin are frequently used.

FIG. 8 is a sectional view showing this kind of conventional speaker diaphragm made of resin. Diaphragm 87 has, at the center thereof, a hole to which a voice coil (not shown) is fitted and bonded, and has, at the circumference thereof, edge 89 that is a bonding portion for bonding diaphragm 87 to a frame (not shown). This is the most common configuration.

Furthermore, as a method of manufacturing such a speaker diaphragm made of resin, when a speaker diaphragm has a relatively large hole diameter and large thickness, an injection molding process is employed. The injection molding process can be carried out at high precision and applied also for complicated shapes. However, it is difficult to mold a thin speaker diaphragm. Further, since a long molding time is required, the productivity is lowered.

Furthermore, when a speaker diaphragm has a small hole diameter and small thickness, a method of forming a resin film by using a mold is generally employed. An example of the method of forming a resin film by using a mold includes a method using a pair of male and female molds that have been processed for forming a resin film into a predetermined shape of a diaphragm and a method of air-pressure forming or vacuum forming by using one mold that has been processed for forming a resin film into a predetermined shape of a diaphragm.

Recently, the market has strongly demanded a low cost and high productivity. Therefore, in particular, in a method of manufacturing a small size speaker diaphragm, a method of pressing by using a pair of male and female molds and a method of air-pressure forming or vacuum forming by using one mold are becoming a mainstream. Among them, the method of air-pressure forming or vacuum forming by using one mold is more excellent than the method of pressing by using a pair of male and female molds in terms of reducing the cost and enhancing productivity. Therefore, it's no exaggeration to say that the method of air-pressure forming or vacuum forming by using one mold has becoming a mainstream in the method of manufacturing a speaker diaphragm using a resin film.

FIG. 9 is a flow chart of manufacturing process showing a method of manufacturing a conventional speaker diaphragm in which air-pressure forming is carried out by using one mold.

Furthermore, FIG. 10 is a block diagram showing conventional production facility 300 for a speaker diaphragm.

As shown in FIG. 10, a conventional production facility includes mold 8 for forming a diaphragm into a predetermined shape, and discharge valve 5 that is a discharger of compressed air.

In detail, conventional production facility 300 includes boosting device 1, supplied air 2, booster 3, pressure control valve 4, discharge valve 5, supplied air 6, stage 7, mold 8, heater 9, temperature sensor 10, heating block 11 and pressure sensor 12.

By using production facility 300, a sheet-like film material that has been prepared as a diaphragm material in advance (S911) is input into stage 7 (S902). While the film is heated by using a mold that has been heated in advance (S901), the material is clamped by stage 7 and mold 8 (S903) and a predetermined pressure is applied by air pressure (S904). Thereby, the film material was molded along mold 8.

Then, the mold is cooled (S905). At the time when the temperature of a molded product is decreased and the shape becomes stable, clamping of the mold is carried out (S906) and the molded product is released and removed from mold 8 (S907).

Then, by a punching die, the outer shape of the diaphragm is formed and the diaphragm is obtained.

Herein, when pressure is applied by air, a pressure of 0.8 MPa or less is applied for a predetermined time without changing the pressure. Thus, the forming is carried out along a mold.

An example of the prior art related to the invention of this application includes Japanese Patent Unexamined Publication No. S55-162696, Japanese Patent Examined Publication No. H7-101953, or the like.

However, a conventional manufacturing method of a speaker diaphragm of carrying out air-pressure forming by using one mold as mentioned above has the following problems. That is to say, since a sheet-like film material that has been prepared in advance is molded, it has been difficult to achieve a complicated shape and precision. Furthermore, in order to avoid the occurrence of deformation, shape distortion, dimensional error, and the like, it has been necessary to strictly manage the forming time and forming temperature.

Note here that in order to secure a complicated shape, precision, and further shape stability, it is necessary to carry out a process of increasing the air pressure at the time of air-pressure forming, forming a material along a mold without clearance, and maintaining the heating for a predetermined time. However, when the air pressure is raised, when the material is thin, since the film is softened rapidly around Tg (glass transition point), the film material may be broken.

Furthermore, also after forming, when the forming was not strict, there was a tendency that a part having a complicated or deep shape was deformed and the shape returned to the original sheet shape due to the occurrence of spring back.

### SUMMARY OF THE INVENTION

The present invention addresses the problems discussed above, and aims to provide an excellent speaker diaphragm capable of improving the performance as a speaker and achieving a good productivity in which problems such as breakage does not occur and forming is carried out at high precision even when a diaphragm has a complicated shape.

In order to solve the above-mentioned problems, a method of manufacturing a production facility for a speaker diaphragm and the speaker diaphragm using the production facility in accordance with the present invention carries out forming by stepwise controlling the pressure and the flow of compressed air when a sheet-like film material is formed along a mold in the production facility for a speaker diaphragm for forming a film by air-pressure forming so as to obtain a diaphragm.

As mentioned above, when a speaker diaphragm is manufactured by using a production facility in accordance with the present invention, by forming a sheet-like film material by stepwise controlling the pressure and the flow of compressed air at the time of air-pressure forming, a diaphragm, even when it has a complicated shape can be manufactured at high precision.

### BRIEF DESCRIPTION OF THE DRAWINGS

FIG. 1 is a block diagram showing a production facility of a diaphragm in accordance with one exemplary embodiment of the present invention.

FIG. 2 is a flow chart of manufacturing process of a diaphragm in accordance with one exemplary embodiment of the present invention.

FIG. 3 is a flow chart of manufacturing process of a diaphragm in accordance with another exemplary embodiment of the present invention.

FIG. 4 is a sectional view showing a diaphragm in accordance with one exemplary embodiment of the present invention.

FIG. 5 is a sectional view showing a speaker in accordance with one exemplary embodiment of the present invention.

FIG. 6 is a sectional view showing a principal part of electronic equipment in accordance with one exemplary embodiment of the present invention.

FIG. 7 is a sectional view showing a device in accordance with one exemplary embodiment of the present invention.

FIG. 8 is a sectional view showing a conventional diaphragm.

FIG. 9 is a flow chart of manufacturing process of a conventional diaphragm.

FIG. 10 is a block diagram showing a conventional production facility of a conventional diaphragm.

### REFERENCE MARKS IN THE DRAWINGS

1 boosting device
2 supplied air
3 booster
4 pressure control valve
5 discharge valve
6 supplied air
7 stage
8 mold
9 heater
10 temperature sensor
11 heating block
12 pressure sensor
13 stepwise pressure controller
17 diaphragm
51 magnet
52 top plate
53 yoke
54 magnetic circuit
55 magnetic gap
56 frame
58 voice coil
30 speaker
40 electronic circuit
60 display module
70 exterior case
80 portable telephone
90 automobile

### DETAILED DESCRIPTION OF THE PREFERRED EMBODIMENTS

The present invention relates to a manufacturing method of forming a speaker diaphragm by stepwise controlling a pressurizing process by using a production facility having a stepwise pressure controller in accordance with the present invention when a sheet-like film material is molded along a mold. With the manufacturing method of the present invention, a diaphragm can be molded at high precision even when the diaphragm has a complicated shape.

Herein, the stepwise pressure controller is a device capable of stepwise controlling the pressure and the flow of compressed air. A stepwise controlling method is not particularly limited to a method of stepwise increasing the pressure and the flow sequentially. It may freely set to a method of sequentially reducing the pressure and the flow or a method of repeating increasing and reducing the pressure and the flow. The control pattern can be set to an optimal pattern in accordance with the property of materials to be molded. Hereinafter, the most common stepwise control is described as an example.

The manufacturing method of the present invention can avoid breakage of a sheet-like film material and can improve the stability of the dimension and the shape, the quality and reliability of a diaphragm. In addition, it is possible to improve properties such as a sound pressure frequency property, distortion properties, and the like, of a speaker using the diaphragm. Furthermore, since the thickness of a diaphragm material can be reduced, a diaphragm suitable for allowing a speaker to have a small size and a high sound pressure.

Furthermore, with the production facility of the present invention, by finely controlling the pressure and the flow of compressed air in accordance with the physical property and moldability of a film material to be used, the film material can be formed without difficulty and residual stress can be reduced. As a result, it is possible to prevent a sheet-like film material from being broken and to reduce a spring back force to return to an original sheet shape. Thus, it is possible to improve the stability of the dimension and the shape, the quality and reliability of the diaphragm.

Thus, the present invention can provide a speaker diaphragm and a speaker capable of improving the performance and quality. Furthermore, the present invention can provide electronic equipment and device on which such a speaker is mounted. The industrial applicability thereof is extremely great.

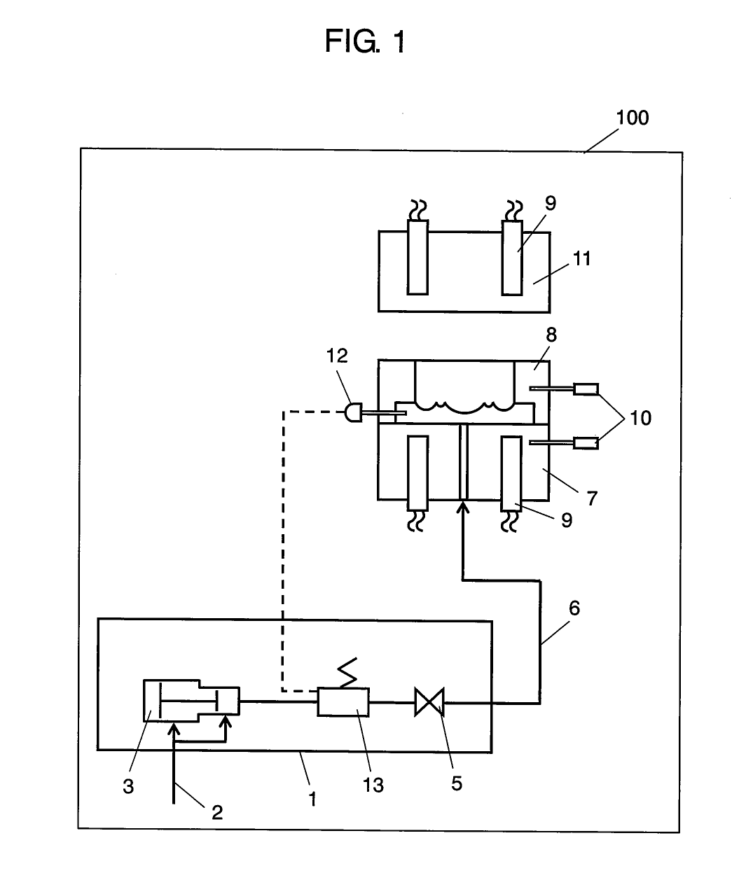

Hereinafter, the embodiments of the present invention are described with reference to FIGS. 1 to 7.

### First Exemplary Embodiment

Firstly, a production facility of the present invention is described.

FIG. 1 is a block diagram showing production facility 100 for a speaker diaphragm in accordance with a first exemplary embodiment of the present invention. Note here that the same reference numerals are given to the same elements having the same functions as those of a conventional facility.

As shown in FIG. 1, production facility 100 includes at least mold 8 for forming diaphragm 17 into a predetermined shape, discharge valve 5 that is a discharger of compressed air, and stepwise pressure controller 13.

Production facility 100 is different from conventional production facility 300 in that production facility 100 includes stepwise pressure controller 13 capable of controlling the pressure of compressed air.

Production facility 100 in accordance with this exemplary embodiment includes boosting device 1, supplied air 2, booster 3, discharge valve 5, supplied air 6, stage 7, mold 8, heater 9, temperature sensor 10, heating block 11, pressure sensor 12, and stepwise pressure controller 13 capable of controlling the pressure of compressed air.

In a conventional facility, although a pressure control valve was provided and pressure was able to be set, during filling of compressed air, only a constant pressure was able to be applied.

On the contrary, since production facility 100 of the first exemplary embodiment of the present invention includes stepwise pressure controller 13, the pressure of compressed air can be set arbitrarily during filling of the compressed air. That is to say, it is possible to adjust the pressure and the pressurizing time freely.

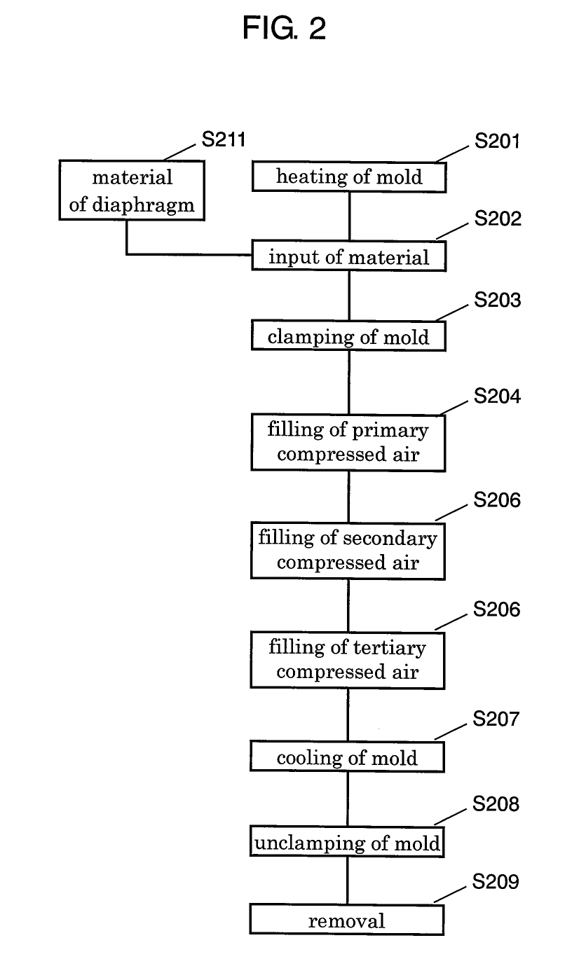

Next, a method of manufacturing a speaker diaphragm by using production facility 100 of the first exemplary embodiment is described with reference to FIG. 2.

In step S211, a sheet-like film material that is a material of the diaphragm is prepared in advance.

In step S201, mold 8 and heating block 11 are heated to a predetermined temperature while the temperature is monitored by temperature sensor 10.

In step S202, the prepared sheet-like film material is input into stage 7 in production facility 100.

In step S203, clamping of a mold is carried out by stage 7 and mold 8 in a state in which a film material is heated by heating a mold.

In steps S204 to S206, the material is formed along mold 8 by stepwise applying pressure by using the air pressure of supplied air 6. In pressurizing, an appropriate pressure for each step is maintained while pressure is monitored by pressure sensor 12.

In step S207, mold 8 is cooled.

In step S208, mold 8 is cooled while the temperature is monitored by temperature sensor 10, and at the time when the shape of the molded film is stable, unclamping of a mold is carried out.

In step S209, a diaphragm molded product is released and removed from mold 8.

Then, by using a punching die, the outer shape of the diaphragm is punched, and diaphragm 17 is obtained.

Herein, as this method of applying pressure by air pressure, conventionally, pressurizing is carried out with the pressure of compressed air maintained at constant. On the contrary, in the manufacturing method in accordance with the first exemplary embodiment, forming is carried out by stepwise controlling the pressure of compressed air.

That is to say, forming is carried out while the pressure of compressed air is stepwise controlled in a way in which the primary air is filled (S204), next, by changing the pressure, the secondary compressed air is filled (S205), and further, by changing the pressure, the tertiary compressed air is filled (S206).

Thereafter, when a temperature of the molded product is reduced by cooling of mold and the shape of the molded product is stable, unclamping of the mold is carried out so as to release and remove the molded product from mold 8. Then, by using a punching die, the diaphragm is punched out and the outer shape of the diaphragm is formed. Thus, a final product of diaphragm 17 is obtained.

As a method of changing the pressure of compressed air, for example, when a material easily breaks by pressure applied rapidly or when a material is thin, it is effective to stepwise control of the pressure in a way in which the pressure is sequentially increased. That is to say, the primary compressed air is filled at a low pressure, then, the secondary compressed air is filled at a middle pressure, and further, the tertiary compressed air is filled at a high pressure.

Thus, by stepwise controlling the pressure of compressed air, a material that easily breaks or a thin material is molded while it is stretched little by little. Thereby, forming can be carried out in a state in which load applied to the material is reduced. As a result, the occurrence of material breakage can be prevented.

Furthermore, a diaphragm, even when it has a complicated shape, can be molded at high precision without employing injection molding or female and male press molding.

In this case, the temperature control is set to be optimum with respect to a material to be molded while the temperature control of compressed air is related with the pressure of compressed air. Thus, the forming is carried out more effectively and at further high precision.

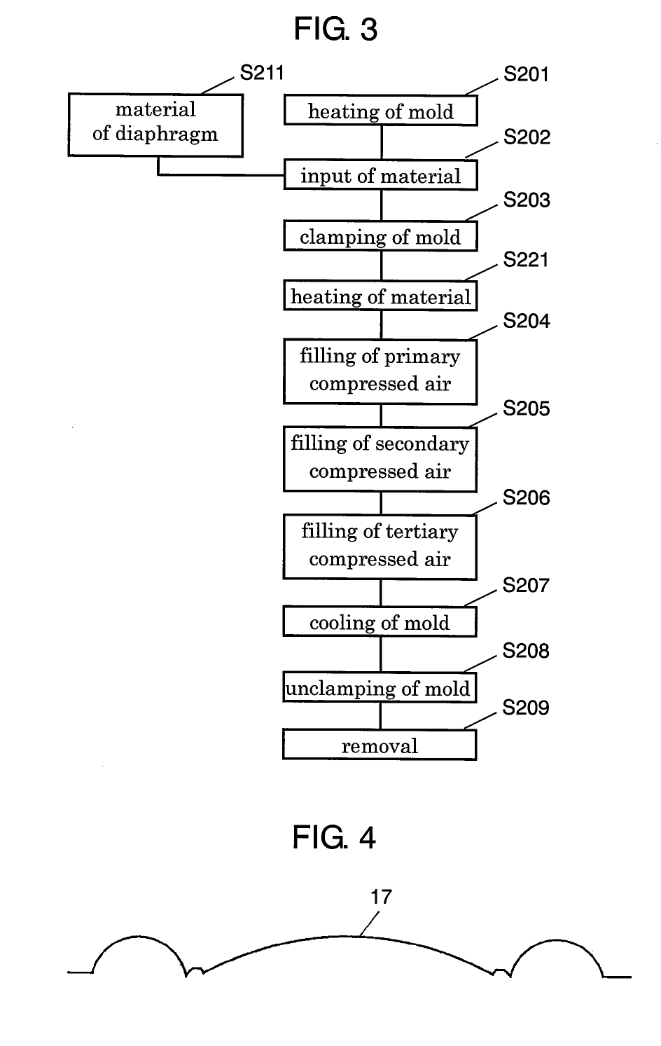

Furthermore, as shown in FIG. 3, by providing step S221 of heating a film and forming thereof before air-pressure forming, a material temperature can be set to a further optimal value. As a result, the material can be prevented from being broken, and a diaphragm, even when it has a complicated shape or a deep shape, can be formed at high precision, and shape stability can be improved.

As this film heating device, a means of heating with a mold, that is, a method of raising a temperature of a film material by using a heater for heating the mold. Furthermore, by providing a pre-heating step in advance, a method of directly heating a film material may be employed by using infrared heating equipment, a hot air dryer, and the like.

Since a film heating device is provided, a diaphragm, even when it has a complicated shape, can be molded at high precision. Thus, the sheet-like film material can be prevented from being broken and at the same time, the stability of the dimension and the shape, the quality and reliability of the diaphragm can be improved.

The above-mentioned exemplary embodiment describes a manufacturing method in which the pressure of compressed air is sequentially increased in three levels. However, the method is not particularly limited to this exemplary embodiment, and the method is effective as long as the pressure of compressed air is increased in two levels or more.

Furthermore, a method of stepwise controlling the pressure of compressed air is not limited to a method of stepwise increasing the pressure sequentially. It may be freely set to a method of sequentially reducing pressure or a method of repeating increasing and reducing pressure. It is desirable that the control pattern can be set to an optimal pattern in accordance with the property of materials to be molded.

### Second Exemplary Embodiment

Next, a forming method of stepwisely controlling flow of compressed air by using stepwise pressure controller 13 of the present invention is described with reference to the second exemplary embodiment. Since there are many steps common to those of the first exemplary embodiment, the second exemplary embodiment is described with reference to FIGS. 1 and 2.

The manufacturing method in accordance with the second exemplary embodiment has the same effect as the forming method of stepwisely controlling the pressure of compressed air as mentioned above. Instead of stepwise control of the pressure by using stepwise pressure controller 13, the flow of compressed air is stepwise controlled. In other words, this manufacturing method carries out control while the pressure time is changed under a constant pressure.

Production facility 100 of the second exemplary embodiment is a production facility capable of stepwise executing flow control means by using stepwise pressure controller 13.

In the manufacturing method of the first exemplary embodiment, in steps S204 to S206, compressed air having different pressures was filled respectively. On the contrary, in accordance with the manufacturing method of the second exemplary embodiment, in steps S204 to S206, compressed air having different flow is filled respectively. Controlling the flow is changing a maintaining time at a predetermined pressure, thus a predetermined pressure is applied to each of steps S204 to S206 for different period of time, respectively.

Note here that a production facility capable of carrying out fine control by using both pressure control means and flow control means can be employed.

As described in the first and second exemplary embodiments, by using production facility 100 of the present invention, the pressure and the flow of compressed air can be controlled finely depending upon the physical property or moldability of film materials to be processed. As a result, a film, even when it is thin, can be molded without difficulty and the residual pressure can be reduced.

Furthermore, it is possible to prevent a sheet-like film material from being broken and to reduce a spring back force to return to an original sheet shape. Thus, it is possible to improve the stability of the dimension and the shape, the quality and reliability of the diaphragm.

Furthermore, since the flow of compressed air can be controlled in accordance with the property or the physical property of materials to be molded and the form or performance of the manufacturing method, or the flow controlling method can be combined with the pressure controlling method, the pressure and the flow of the compressed air can be finely controlled.

By using the production facility of the present invention, higher precise forming can be carried out and materials can be prevented from being broken. In addition, the stability of the dimension and the shape, the quality and reliability of the diaphragm can be further improved.

Furthermore, unlike a conventional facility, since forming is carried out by setting the maximum pressure of compressed air to 0.8 MPa or more, a sheet-like film material can be formed along a mold more strongly. A diaphragm, even when it has a complicated shape or deep shape, can be formed at high precision and the shape stability can be improved.

Conventionally, when a pressure of 0.8 MPa or more is applied for a predetermined time or longer without changing it, films may be broken frequently depending upon materials or film thickness. By using a production facility capable of stepwise controlling the pressure and the flow in accordance with the present invention, choice of film materials is widened and a thin film can be molded.

Furthermore, a mold may be provided with a cooling device.

When the cooling device is provided, the temperature decrease after forming can be promoted and the time until a shape of the diaphragm becomes stable can be shortened. Thus, productivity of the diaphragm can be improved.

By using the manufacturing method, a film having a thickness of 3 μm to 500 μm can be molded and a large effect can be obtained.

When the thickness of the diaphragm material is thin in the range from 3 μm to 500 μm, a large effect can be obtained with respect to the breakage of the material. On the other hand, when the thickness is large, the moldability and productivity can be improved.

Note here that when a diaphragm has a thickness of 500 μm or more, injection forming is suitable rather than film forming.

Furthermore, it is preferable that a heating temperature at the time of forming a diaphragm is 100° C. or more and 400° C. or less.

This is a temperature range allowing almost all materials of a diaphragm produced from a film material to be molded and is a temperature range necessary to derive a stable shape keeping performance after forming.

By setting to this temperature range, productivity and versatility can be improved.

Needless to say, it is important in improving the moldability that a temperature is set at high precision independently depending upon materials to be used.

Furthermore, it is preferable that a cooling temperature at the time of forming a diaphragm is 80° C. or more and 300° C. or less.

This is a temperature range allowing the shape of a diaphragm molded by using a film material to be maintained stably and is necessary to eliminate the problems that shape after forming cannot be kept due to spring back and to derive a performance of the diaphragm after forming.

By setting to this temperature range, the releasing property and shape stability after releasing can be improved, and productivity and versatility can be improved.

Needless to say, it is important in improving the releasing property and the shape stability after release that a temperature is set at high precision independently depending upon materials to be used.

Furthermore, when a film mainly containing fully aromatic polyimide resin as a main component or a film mainly containing polyethylene naphthalate resin as a main component is used as a material of the diaphragm in the manufacturing method of the present invention, the manufacturing method can provide a large effect.

A film material using an engineering plastic such as a film mainly containing fully aromatic polyimide resin as a main component or a film material mainly containing polyethylene naphthalate resin as a main component is a material that is extremely excellent as an acoustic material. However, it is extremely difficult to mold such materials. Since such materials are not good in moldability and productivity, it has conventionally been difficult to use them for a diaphragm. By using such materials in the manufacturing method of the present invention, the moldability and productivity thereof can be remarkably improved. Thus, the performance and productivity as a diaphragm can be improved.

Furthermore, a material can be cooled quickly by cooling with a water cooling device, resulting in shortening the cooling time and improving the cooling efficiency. Thus, the productivity of diaphragm can be improved.

On the other hand, by cooling with an air cooling device, materials can be cooled slowly and crystallization of materials can be stabilized. Therefore, an excellent property as a diaphragm can be secured.

Furthermore, by carrying out cooling, the facility cost can be reduced. Thus, the cost of the diaphragm can be reduced.

### Third Exemplary Embodiment

In the third exemplary embodiment, an example of manufacturing a speaker diaphragm by using the present invention is described.

FIG. 4 shows speaker diaphragm 17 obtained by the manufacturing method described in the first exemplary embodiment of the present invention.

As described in the first and second exemplary embodiments, with the method of manufacturing a speaker diaphragm of the present invention, a sheet-like film material can be formed along a mold by stepwise controlling the pressure or the flow of compressed air, and diaphragm having a complicated shape or a deep shape can be obtained.

Furthermore, a diaphragm with high dimensional precision, a diaphragm in which a film material is not broken, and a diaphragm capable of improving the shape stability after forming and having high quality and reliability can be obtained.

In particular, as a material of the diaphragm, an engineering plastic such as a film mainly containing fully aromatic polyimide resin as a main component or a film mainly containing polyethylene naphthalate resin as a main component is used. By manufacturing a diaphragm by applying the films to the manufacturing method of the present invention, a diaphragm with high reliability can be obtained.

### Fourth Exemplary Embodiment

In the fourth exemplary embodiment, an example of manufacturing a speaker diaphragm by using the manufacturing method described in the first and second exemplary embodiments and manufacturing a speaker by using diaphragm 17 is described.

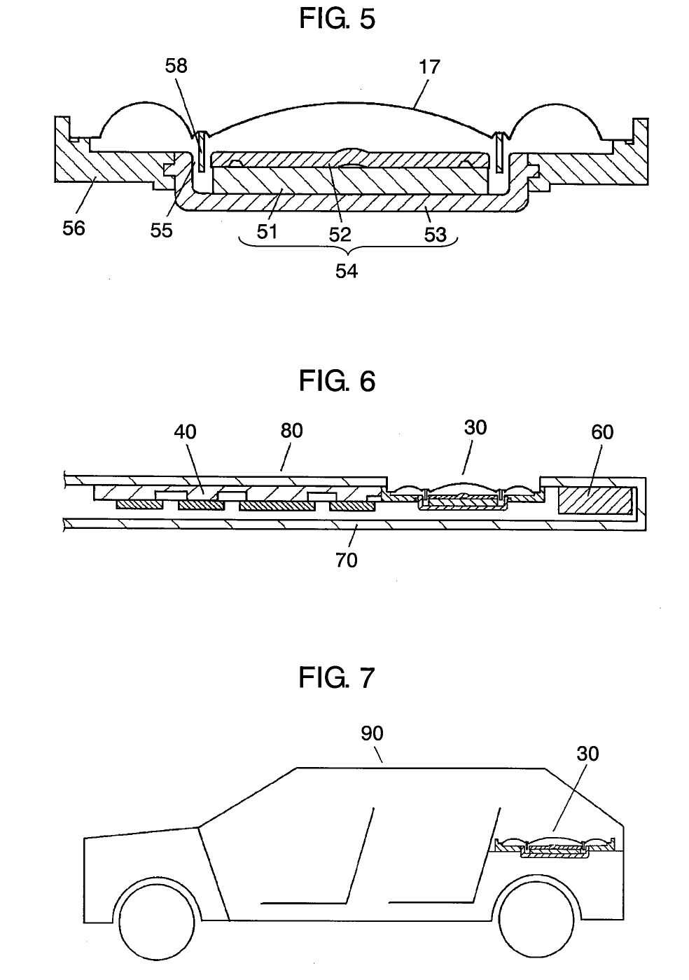

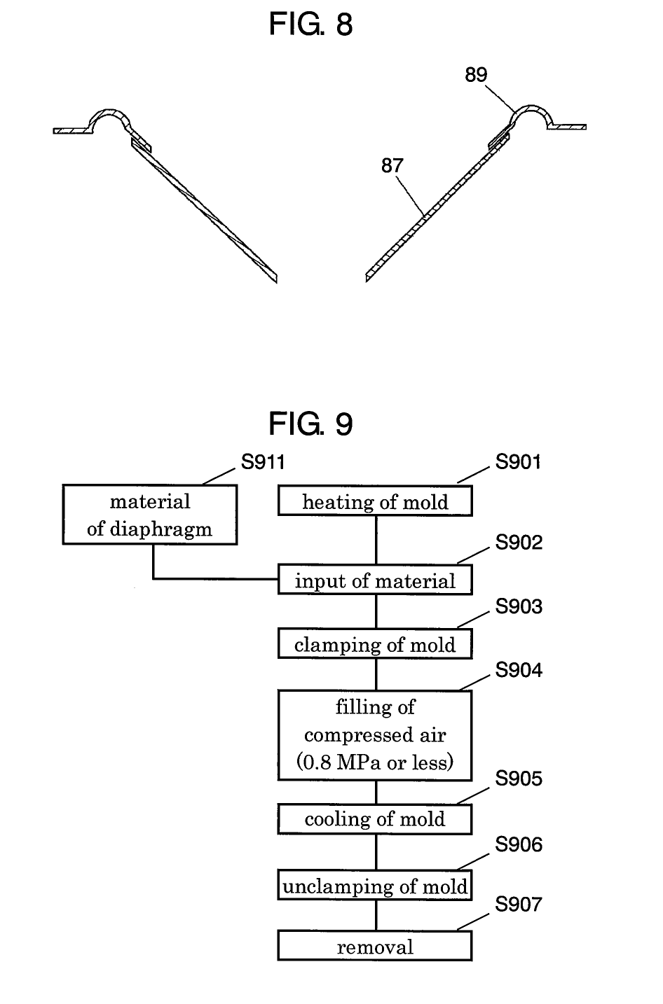

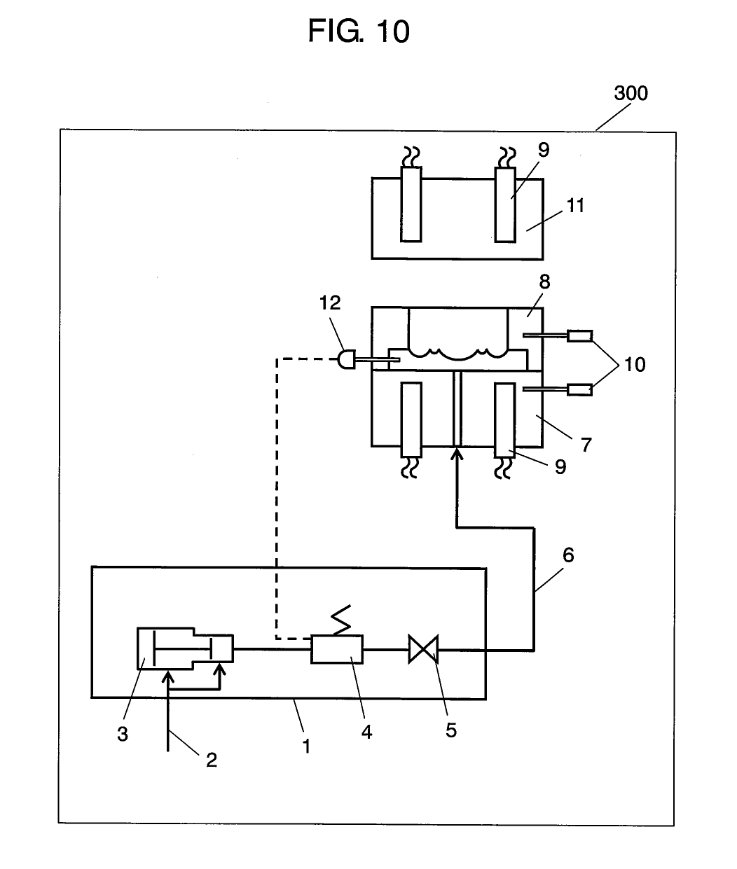

FIG. 5 is a sectional view showing a speaker in accordance with one exemplary embodiment of the present invention.

As shown in FIG. 5, magnetized magnet 51 is sandwiched by top plate 52 and yoke 53 so as to configure magnetic circuit 54.

To yoke 53 of magnetic circuit 54, frame 56 is coupled. To a circumference portion of frame 56, diaphragm 17 is bonded. To diaphragm 17, voice coil 58 for driving diaphragm 17 is bonded.

Then, voice coil 58 is bonded to magnetic gap 55 of magnetic circuit 54 in a way in which voice coil 58 is fitted into magnetic gap 55 so as to configure a speaker.

Herein, diaphragm 17 is manufactured by using the manufacturing method described in the first or second exemplary embodiment. That is to say, even when a diaphragm has a complicated shape or a deep shape, it is possible to produce a diaphragm having high quality and high reliability, which has a high dimensional precision, is free from breakage of a film material, and is capable of improving shape stability after forming.

With such a configuration, low distortion and high linearity of a speaker can be achieved, so that a high performance speaker capable of replaying excellent tone quality.

Furthermore, the productivity, quality and reliability as a speaker can be improved.

As mentioned above, the effect of the case in which diaphragm 17 of the present invention is used for a speaker is described. The use of diaphragm 17 is not limited to a speaker and can be used for all of electro-acoustic transducers such as a receiver, microphone, and the like.

### Fifth Exemplary Embodiment

The fifth exemplary embodiment describes electronic equipment on which a speaker diaphragm produced in the third exemplary embodiment is mounted.

FIG. 6 is a sectional view showing a principal part of a portable telephone that is electronic equipment in accordance with one exemplary embodiment of the present invention. That is to say, FIG. 6 shows portable telephone 80 on which speaker 30 that is an electro-acoustic transducer is mounted.

Herein, portable telephone 80 includes components or modules such as speaker 30 on which a speaker diaphragm produced in the third exemplary embodiment is mounted, electronic circuit 40 provided with an amplifier of electronic signals input to speaker 30, and display module 60 such as a liquid crystal display. These components or modules are mounted inside the exterior case 70.

With such a configuration, high quality tone, improvement of productivity and improvement of quality of electronic equipment can be realized.

When the manufacturing method of the present invention is used, mass production of small-size and precise diaphragms can be carried out.

### Sixth Exemplary Embodiment

A sixth exemplary embodiment describes an example in which the speaker diaphragm produced in the third exemplary embodiment is mounted on an apparatus provided with movable means is described.

FIG. 7 is a sectional view showing automobile 90 that is an apparatus provided with movable means in accordance with one exemplary embodiment of the present invention. As shown in FIG. 7, speaker 30 on which the speaker diaphragm manufactured in the third exemplary embodiment is mounted is incorporated into a rear tray so as to configure automobile 90.

With such a configuration, high quality tone of automobile 90 including speaker 30 can be realized and improvement of productivity and quality can be realized.

In particular, when the manufacturing method of the present invention is used, a diaphragm using a film material such as an engineering plastic that is excellent in thermal resistance can be molded. Therefore, a speaker suitable to be mounted on automobile that is used in strict environment.

### INDUSTRIAL APPLICABILITY

A speaker diaphragm in accordance with the present invention can be applied to a diaphragm for electro-acoustic transducer used in various acoustic equipment that requires improvement of high quality tone, productivity of a diaphragm, and improvement of quality, as well as electro-acoustic transducer such as a speaker, and further various electronic equipment, various devices, or the like.

1. A production facility for a speaker diaphragm manufactured by air-pressure forming of a film, comprising:
a mold;
a discharger of compressed air; and
a stepwise pressure controller of compressed air;
the stepwise pressure controller being capable of stepwise or arbitrarily controlling pressure of compressed air.

2. The production facility for a speaker diaphragm of claim 1, wherein the stepwise pressure controller carries out at least one of pressure control of compressed air and flow control of compressed air.

3. The production facility for a speaker diaphragm of claim 1, wherein the stepwise pressure controller can control a maximum pressure of compressed air to be 0.8 MPa or more.

4. The production facility for a speaker diaphragm of claim 1, further comprising a mold heating device.

5. The production facility for a speaker diaphragm of claim 1, further comprising a device of heating the film.

6. The production facility for a speaker diaphragm of claim 1, further comprising a mold cooling device.

7. The production facility for a speaker diaphragm of claim 6, wherein the mold cooling device is an air cooling device or a water cooling device.

8. A method of manufacturing a speaker diaphragm by air-pressure forming of a film, the method comprising:
forming, in which the film is pressurized by using compressed air;
wherein the forming includes pressurizing of stepwise controlling the pressurizing of compressed air.

9. The method of manufacturing a speaker diaphragm of claim 8, wherein the pressurizing is stepwise controlling at least one of pressure control of compressed air and flow control of compressed air.

10. The method of manufacturing a speaker diaphragm of claim 8, wherein the pressurizing can set a maximum pressure of compressed air to be 0.8 MPa or more.

11. The method of manufacturing a speaker diaphragm of claim 8, the method comprising heating the film prior to the forming.

12. The method of manufacturing a speaker diaphragm of claim 8, wherein the forming is pressurizing the film having a thickness of 3 μm to 500 μm.

13. The method of manufacturing a speaker diaphragm of claim 8, wherein the forming includes pressurizing the film that has been heated at temperatures of 100° C. or more and 400° C. or less.

14. The method of manufacturing a speaker diaphragm of claim 8, wherein the forming includes cooling a molded product at a temperature of 80° C. or more and 300° C. or less after pressuring.

15. The method of manufacturing a speaker diaphragm of claim 14, wherein the cooling is a quick cooling by using a water cooling device.

16. The method of manufacturing a speaker diaphragm of claim 14, wherein the cooling is a slow cooling by using an air cooling device.

17. The method of manufacturing a speaker diaphragm of claim 8, wherein the film is a film including an engineering plastic as a material.

18. The method of manufacturing a speaker diaphragm of claim 17, wherein the engineering plastic is a plastic including polyethylene naphthalate resin or fully aromatic polyimide resin as a main component.

19. A diaphragm, which is an air-pressure molded product of an engineering plastic film that has been stepwise pressure molded by compressed air pressure.

20. The speaker diaphragm of claim 19, wherein the engineering plastic is a plastic including polyethylene naphthalate resin or fully aromatic polyimide resin as a main component.
